(19) United States
(12) Patent Application Publication
(10) Pub. No.: US 2007/0141304 A1
(43) Pub. Date: Jun. 21, 2007

(54) Perforated board formed from cementitious material and process and system for producing same

(76) Inventor: Gaurav Agrawal, Aurora, CO (US)

Correspondence Address: JOHNS MANVILLE, 10100 WEST UTE AVENUE, LITTLETON, CO, 80127, US

(21) Appl. No.: 11/316,658

(22) Filed: Dec. 21, 2005

(51) Int. Cl. B32B 5/26; B32B 3/10

(52) U.S. Cl. 428/138; 442/381; 442/392; 442/386; 428/137

(57) ABSTRACT

A process for producing a perforated board comprising a cementitious layer and first and second facers is provided, the process comprising: (a) providing a substrate comprising a first facer; (b) applying a slurry comprising a cementitious material on the substrate; (c) providing a second facer above the slurry; and (d) forming a plurality of perforations which extends at least partially into at least one of the first and second facers.

### BACKGROUND

Boards formed from cementitious material are typically used in the construction of modern buildings, for example, as surfaces for both interior and exterior walls and ceilings and the like. Such boards are typically relatively easy and inexpensive to install, finish, and maintain, and in suitable forms, can be relatively fire resistant.

The boards can be formed from a slurry of the cementitious material, such as a gypsum slurry, for example, by mixing at least one of anhydrous calcium sulfate (CaSO₄) and calcium sulfate hemihydrate (CaSO₄.1/2H₂O, also known as calcined gypsum) and water. Facers can be provided on either side of the slurry in order to provide structural rigidity to the boards and/or for aesthetic purposes.

The resulting boards are introduced into a drying oven in order to evaporate excess water from the slurry layer. A problem existing in such drying process is that the water vapor released from the slurry can produce blisters, bubbles and other defects on the facers surrounding the slurry layer. The existence of such blisters, bubbles and other defects can detract from the aesthetics of the boards, and/or can lead to the delamination of the facers. In addition, such defects can remain conspicuous even after the facers are painted or further treated. The undesirable formation of the defects described above can be exacerbated when facer materials having low air-permeability characteristics are used.

In view of the above, there exists a need for reducing or substantially eliminating the formation of blisters, bubbles and other defects in the facers during the manufacture of boards formed from a cementitious material.

### SUMMARY

According to one aspect, a process for producing a perforated board comprising a cementitious layer and first and second facers is provided, the process comprising:

(a) providing a substrate comprising a first facer;

(b) applying a slurry comprising a cementitious material on the substrate;

(c) providing a second facer above the slurry; and

(d) forming a plurality of perforations which extends at least partially into at least one of the first and second facers.

According to another aspect, a perforated board is provided, comprising:

(a) a layer comprising a cementitious material, and having a first face and a second face; and

(b) first and second facers arranged adjacent to or in contact with the first and second faces of the layer comprising a cementitious material, respectively, wherein a plurality of perforations is disposed in at least one of the first and second facers, and wherein the plurality of perforations extends at least partially into the at least one facer.

According to a further aspect, a system for producing a perforated board comprising a cementitious layer and first and second facers is provided, the system comprising:

(a) a conveyor for conveying a substrate comprising a first facer;

(b) a source of a slurry comprising a cementitious material, wherein the source is arranged to provide the slurry to the substrate;

(c) a conveyor for conveying a second facer above the first facer; and

(d) a perforating device for forming a plurality of perforations which extends at least partially into at least one of the first and second facers.

### BRIEF DESCRIPTION OF THE DRAWINGS

FIG. 1 is a cross-sectional view of a perforated board, according to one exemplary aspect.

FIG. 2 is a perspective view of a perforated board, according to another exemplary aspect.

FIG. 3 is a schematic view of a line for the manufacture of a perforated board, according to another exemplary aspect.

FIG. 4 is a schematic view of a line for the manufacture of a perforated board, according to a further exemplary aspect.

### DETAILED DESCRIPTION

Referring to FIG. 1, a cross-sectional view of an exemplary perforated board 100 is shown. The perforated board comprises a layer 110 comprising a cementitious material. The cementitious material can include any material suitable for use in the production of a board for use as a wallboard, ceiling panel or the like. For example, the cementitious material can be selected from gypsum, Portland cement, a pozzolanic material or a combination thereof. Preferably, the cementitious material can include at least gypsum.

The layer 110 comprising the cementitious material is disposed between first and second facers 120 and 130. The first and second facers 120 and 130 can be directly attached to the cementitious material, or an intermediate layer can be disposed between either of the facers and the material. The first and second facers 120 and 130 can be attached to the layer 110 by use of an adhesive or binder, and/or the cementitious material itself can be effective to form a bond with the facers 120 and 130.

The cementitious material can include various additives such as, for example, set accelerants, waterproofing agents, defoaming agents, dispersants and/or biocides. The additives can be added at any suitable stage during the manufacturing process of the perforated board 100. For example, cellulose and/or glass fibers can be included in the cementitious material to provide structural reinforcement to the board 100. Optionally, starch can also be added during production of the layer 110 in order to improve the adhesion between the cementitious core and the facers 120 and 130.

The first and second facers 120 and 130 can include any suitable facing material such as, for example, a paper material, a non-woven fiberglass mat or a combination thereof, and preferably include the non-woven fiberglass mat. The facers 120 and 130 can each be formed from a single layer or multiple layers of material. In an exemplary embodiment, each facer 120 and 130 can include a first layer 122 and 132, and a second layer 124 and 134, respectively, wherein the first layers comprise a non-woven fiberglass mat and the second layers 124 and 134 are formed from a material such as a coating or a laminate. While in FIG. 1, the second layers 124 and 134 are shown to be the outermost layers of the facers 120 and 130, in alternative embodiments such layers can constitute intermediate or innermost layers of the facers 120 and 130, respectively. The second layers 124 and 134 can be formed from a material that enables controlling the permeability of the facers 120 and 130, such as a material that is substantially impermeable to air which can be selected from, for example, a polymeric material such as polyethylene or a cellulosic material. The material can optionally include additives to improve the mechanical properties thereof including, for example, organic or inorganic particles. In one or both facers, the second layer can be attached to the first layer (for example, a fiberglass matt) by any suitable technique such as by coating or lamination.

The non-woven fiberglass mat which can be used in at least one facer, and preferably both facers, comprises glass fibers bonded together with a resinous binder. Exemplary fiberglass mats which can be used are disclosed in U.S. Patent Application Publication Nos. 2004/0266303 and 2004/0266304, each published on Dec. 30, 2004, the contents of which are incorporated herein by reference. Any suitable glass fibers can be used including, for example, chopped strand fibers, staple fibers or mixtures thereof. The fiberglass mats can contain various additives such as fillers, pigments, or other inert or active ingredients either throughout the mat or concentrated on a surface. The glass fibers can be bound together with any known water-resistant resinous binder. For example, suitable binders include urea formaldehyde; conventional modified urea formaldehyde; acrylic resins; melamine resins, preferably having a high nitrogen resins such as those disclosed in U.S. Pat. No. 5,840,413; homopolymers or copolymers of polyacrylic acid having a molecular weight of less than 10,000, preferably less than 3,000; crosslinking acrylic copolymer having a glass transition temperature (GTT) of at least about 25 degrees C., crosslinked vinyl chloride acrylate copolymers having a GTT preferably no higher than about 113 degrees C.; and other known flame and water resistant conventional mat binders. Aqueous modified and plasticized urea formaldehyde resin binders may be used and have low cost and acceptably high performance.

The dimensions of the perforated board and the various layers thereof are not particularly limited, and can depend on the specific application of the board. For example, the overall thickness of the perforated board can be from about 0.25 inch to about 1 inch, more preferably from about 0.5 inch to about 0.625 inch. In an exemplary embodiment, the perforated board can have a width of at least about 2 feet, such as a width of about 4 feet. In an exemplary embodiment, the length of the board can be at least about 2 feet, such as from about 8 feet to about 12 feet. While the board is described as containing a “layer” formed from a cementitious material, it will be understood that in exemplary embodiments the boundaries of such layer with adjoining materials can become somewhat indistinct or blurred during the setting and hardening of the cementitious material slurry.

At least one of the facers has a plurality of perforations which extends at least partially into the facer. The plurality of perforations formed in the at least one facer is preferably effective to reduce or prevent the formation of surface defects such as blisters and bubbles during the drying process of the board. Such defects are conventionally caused, for example, by water vapor escaping from the cementitious layer and being impeded by the facers between which the cementitious layer is arranged. Preferably, the at least one perforated facer has a Gurley permeability of about 60 seconds or less, more preferably about 20 to about 40.

Use of the plurality of perforations can enable the substantial control and adjustment of the permeability of the facers and board. For example, in an exemplary embodiment, by employing the plurality of perforations to control the permeability, a board can be formed which enables water vapor to vent through the facers during a drying process of the board, while at the same time maintaining sufficient resistance to liquid water penetration through the facer after completion of the board.

As shown in FIG. 1, in an exemplary embodiment, both facers 120 and 130 have a plurality of perforations formed therein (126A, 126B, 126C and 136A, 136B, 136C, respectively) which extend through the facers. For example, the perforations can extend at least through the entire width of the facer, but not necessarily through the cementitious layer. In an alternative embodiment as shown in FIG. 5, the plurality of perforations can extend only partially through the facers 120 and 130, for example, through the second layers of each facer. Each second layer can be formed from a coating or laminate, for example, that has a lower permeability to water vapor in comparison with the first layer, and the formation of perforations therethrough can be effective to adjust or control the permeability of the facer.

In a preferred embodiment, the perforations are of a size that enables water vapor to escape therethrough during the drying process of the board, and at the same time such perforations are of size that enables the reduction or substantially prevention of the penetration of liquid water through the facer and, for example, into the cementitious layer. For example, the average size of the perforations can be from about 0.01 to about 0.05 inch. Preferably, the plurality of perforations can be of a sufficiently small size so as to not be visually conspicuous. The perforations can be distributed in any manner on the surface of the facer, and preferably in a manner which maximizes reduction of the formation of blisters, bubbles and other surface defects formed during the drying process. For example, in an exemplary embodiment, the perforations can be substantially evenly distributed over the area of the at least one perforated facer. Preferably, as a result of having the perforations, the at least one perforated facer can be substantially free of blisters and bubbles. As used herein, the phrase “substantially free of blisters and bubbles” refers to the lack of any blisters and bubbles on the perforated facer upon visual observation thereof by the naked eye. A perspective view of the perforated board 100 is shown in FIG. 2.

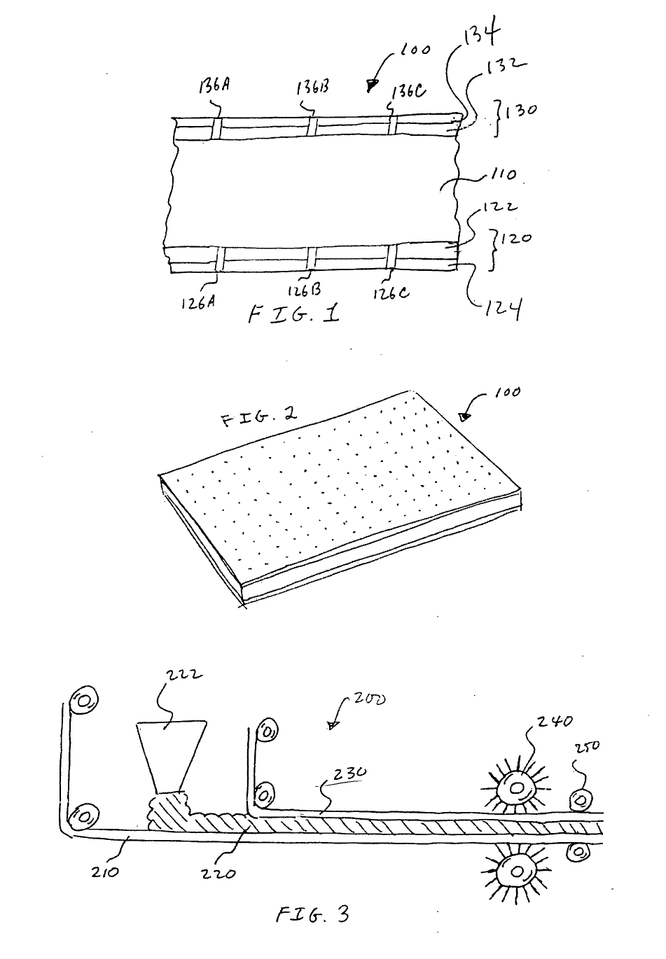

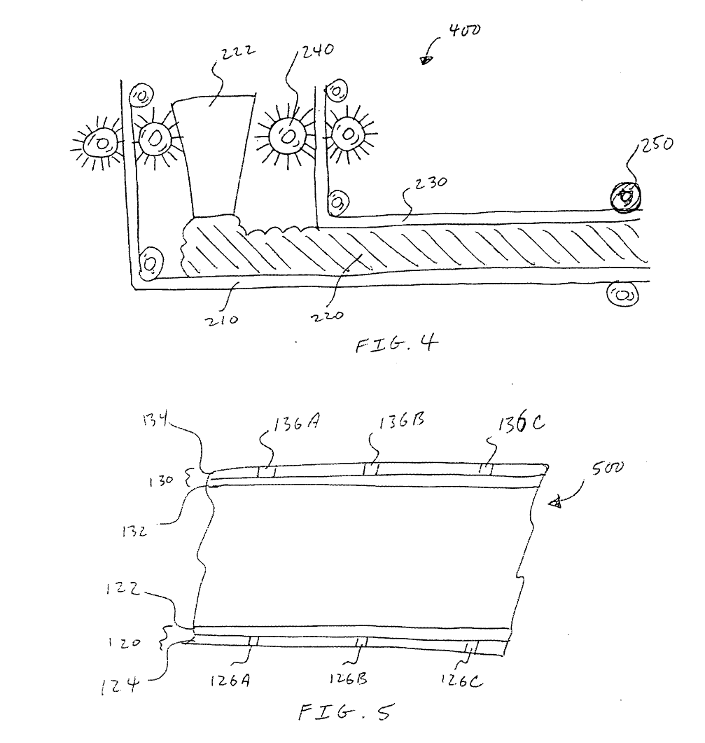

Referring to FIG. 3, an exemplary production line 200 for the production of a perforated board is shown. A substrate 210 comprising a first facer is provided, for example, from a substrate roll (not shown). The substrate 210 can consist of only the first facer, or the substrate 210 can include at least one additional layer such as a layer for improving the structural rigidity of the first facer. The substrate 210 can be conveyed in a substantially continuous manner by employing a conveyer belt, a plurality of rollers and/or any other suitable means.

A slurry 220 comprising a cementitious material (such as gypsum slurry) can be provided from a slurry source 222, and the slurry 220 can be applied onto the substrate 210, for example, as the substrate 210 is conveyed underneath the slurry source 222. The flow rate of the slurry 220 to the substrate 210 can depend on, for example, the desired thickness of the resulting core layer of the board, and the contents of the slurry. A second facer 230 can then be provided above the applied slurry 220 and, for example, in contact with the applied slurry 220. The facers and the slurry can be passed between parallel upper and lower forming plates or rolls 250 in order to generate an integrated and continuous flat strip of unset cementitious material sandwiched between the facers.

The resulting material can be subjected to a setting process, in which the cementitious slurry material present between the facers is allowed to become hardened. The setting process can include conveying the material over a series of continuous moving belts and/or rollers (not shown) for a predetermined period of time, during which time the cementitious core of the material can become hardened. For example, in the case of the use of a gypsum slurry, such slurry at this stage can hydrate back to gypsum (CaSO₄.2H₂O).

The facers can be conveyed to a perforating device 240, which forms a plurality of perforations which extend at least partially into at least one of the facers. As shown in FIG. 3, in a preferred embodiment, the perforating device 240 can be effective to form a plurality of perforations in both facers. The perforating device 240 is shown as being located at point after the slurry 220 is applied to the substrate 210, and after the second facer 230 is provided to the slurry 220. However, a perforating device 240 can additionally or alternatively be positioned at a point upstream from the location shown in FIG. 3. For example, as shown in the alternative embodiment depicted in FIG. 4, the first facer can be perforated prior to application of the slurry, and/or the second facer 230 can be perforated prior to being arranged above and adjacent to the applied slurry 220.

The perforating device 240 is effective for forming a plurality of perforations in at least one of the facers. Any suitable mechanism for forming the perforations in the at least one facer can be employed. For example, the perforating device 240 can include at least one rotating cylinder having a plurality of protrusions extending therefrom, wherein the at least one cylinder is mounted to a drive shaft. The protrusions can preferably be sufficiently long to ensure the desired degree of perforation of the facers. For example, the protrusions such as needles can have an average diameter of from about 0.01 inch to about 0.05 inch, and an average length of from about 0.1 inch to about 0.3 inch. The protrusions can be formed from any suitable rigid material such a metallic or non-metallic material. The diameter of the cylinder can be from about 4 inches to about 20 inches. In the case where perforations are formed in both facers, at least two rotating cylinders can be employed as shown in FIG. 2, wherein each rotating cylinder is arranged adjacent to one of the facers. The plurality of protrusions can contact and perforate the facer as the facer is subjected to the action of the perforating device 240, thereby forming the perforations. The rotating cylinder can have a sufficient length so as to extend across the width of the facer to be perforated, such as, for example, from about 3 feet to about 18 feet. In an alternative embodiment, multiple, shorter rotating cylinders can be employed which are positioned in an in-line or staggered configuration. For example, such perforating device 240 can result in the formation of a substantially uniform pattern of perforation on at least one of the facers.

While the production line 200 is shown and described as operating in a substantially continuous manner, it will be understood that a perforated board 100 can alternatively be produced by employing a batch process.

Once the slurry core has set sufficiently, the material can be cut into shorter lengths or even individual boards of a predetermined length. The resulting material can then be conveyed to a drying device such as an oven or kiln, in which an amount of excess water present in the cementitious layer can be removed therefrom in an accelerated manner. For example, during the formation process of a gypsum layer, water exceeding the stoichiometric requirements for driving the gypsum rehydration reaction is typically present in the slurry. The amount of excess water can be emitted through the at least one perforated facer. By use of the at least one perforated facer, drying of the board can be accomplished within an acceptable time period and with the substantial reduction or prevention of the formation of blisters, bubbles, or delamination of the facer. The drying conditions can depend on various factors including, for example, the composition of the slurry material, the dimensions of the board, the line speed, and the degree of perforation of the perforated facer.

The resulting material can then be removed from the drying device, the ends of the material can be trimmed and the material can be cut into desired sizes to form the perforated board product. For example, the perforated boards can be cut into sheets that are nominally about 4 feet wide and about 8 to about 12 feet or more long. After the drying process, the at least one perforated facer can be treated or otherwise covered with an additional material so as to cover the perforations.

The principles, preferred embodiments, and modes of operation of the present invention have been described in the foregoing specification. The invention which is described herein, however, is not to be construed as being limited to the particular forms disclosed, since these are to be regarded as being illustrative rather than restrictive. Variations and changes can be made by those skilled in the art without departing from the scope of the claims. The inventors do not intend to abandon any disclosed embodiments that are reasonably disclosed but do not appear to be literally claimed below, but rather intend any such embodiments to be included in the claims either literally or as equivalents.

1. A process for producing a perforated board comprising a cementitious layer and first and second facers, the process comprising:
(a) providing a substrate comprising a first facer;
(b) applying a slurry comprising a cementitious material on the substrate;
(c) providing a second facer above the slurry; and
(d) forming a plurality of perforations which extends at least partially into at least one of the first and second facers.

2. The process according to claim 1, wherein the cementitious material is selected from the group consisting of gypsum, Portland cement, a pozzolanic material and a combination thereof.

3. The process according to claim 1, wherein step (d) comprises forming a plurality of perforations in each of the first and second facers.

4. The process according to claim 1, wherein each of the first and second facers comprises a non-woven fiberglass mat.

5. The process according to claim 1, wherein the at least one perforated facer has a Gurley permeability of about 60 seconds or less.

6. The process according to claim 1, wherein the at least one perforated facer comprises a layer formed from a substantially air-impermeable material, and wherein the plurality of perforations extends at least through the layer formed from a substantially air-impermeable material, thereby enabling such layer to be permeable to air.

7. The process according to claim 1, further comprising:
(e) drying the board to reduce an amount of water present therein, wherein during the drying step, water vapor is released from the board via the plurality of perforations of the at least one perforated facer.

8. The process according to claim 7, wherein after the drying step, the at least one perforated facer is substantially free of blisters and bubbles.

9. The process according to claim 1, wherein the plurality of perforations extends at least through a coating or a laminate of the facer.

10. The process according to claim 1, wherein the perforations are substantially uniformly distributed over the area of the at least one perforated facer.

11. The process according to claim 1, wherein the step (d) of forming a plurality of perforations in at least one of the first and second facers, is conducted before at least one of steps (b) and (c).

12. The process according to claim 1, wherein the step (d) of forming a plurality of perforations in at least one of the first and second facers, is conducted after steps (b) and (c).

13. The process according to claim 1, wherein the step (c) of forming a plurality of perforations in at least one of the first and second facers, comprises contacting at least one of the first and second facers with at least one rotating cylinder having a plurality of protrusions extending therefrom for forming the plurality of perforations.

14. A perforated board, comprising:
(a) a layer comprising a cementitious material, and having a first face and a second face; and
(b) first and second facers arranged adjacent to or in contact with the first and second faces of the layer comprising a cementitious material, respectively, wherein a plurality of perforations is disposed in at least one of the first and second facers, and wherein the plurality of perforations extends at least partially into the at least one facer.

15. The perforated board according to claim 14, wherein the cementitious material is selected from the group consisting of gypsum, Portland cement, a pozzolanic material and a combination thereof.

16. The perforated board according to claim 14, wherein a plurality of perforations is disposed in each of the first and second facers.

17. The perforated board according to claim 14, wherein each of the first and second facers comprises a non-woven fiberglass mat.

18. The perforated board according to claim 14, wherein the at least one perforated facer has a Gurley permeability of about 60 seconds or less.

19. The perforated board according to claim 14, wherein the at least one perforated facer comprises a layer formed from a substantially air-impermeable material, and wherein the plurality of perforations extends at least through the layer formed from a substantially air-impermeable material, thereby enabling such layer to be permeable to air.

20. The perforated board according to claim 14, wherein the at least one perforated facer is substantially free of blisters and bubbles.

21. The perforated board according to claim 14, wherein the plurality of perforations extends at least through a coating or a laminate of the facer.

22. The perforated board according to claim 14, wherein the perforations are substantially uniformly distributed over the area of the at least one perforated facer.

23. A system for producing a perforated board comprising a cementitious layer and first and second facers, the system comprising:
(a) a conveyor for conveying a substrate comprising a first facer;
(b) a source of a slurry comprising a cementitious material, wherein the source is arranged to provide the slurry to the substrate;
(c) a conveyor for conveying a second facer above the first facer; and
(d) a perforating device for forming a plurality of perforations which extends at least partially into at least one of the first and second facers.

24. The system according to claim 23, wherein the perforating device comprises at least one rotating cylinder having a plurality of protrusions for forming the plurality of perforations.

25. The system according to claim 23, further comprising a drying apparatus for reducing the water content of a cementitious layer of the perforated board.
